(19) United States
(12) Patent Application Publication
(10) Pub. No.: US 2012/0035338 A1
(43) Pub. Date: Feb. 9, 2012

(54) CATALYST COMPONENT USED FOR OLEFIN POLYMERIZATION, PROCESS FOR PREPARING THE SAME, AND CATALYST CONTAINING THE SAME

(76) Inventors: Zhong Tan, Beijing (CN); Lian Yan, Beijing (CN); Xiudong Xu, Beijing (CN); Qilong Zhou, Beijing (CN); Weiwei Song, Beijing (CN); Fengkul Li, Beijing (CN); Shanshan Yin, Bejing (CN); Jinhua Yu, Beijing (CN); Ying Wang, Beijing (CN); Chunghong Ren, Beijing (CN)

(21) Appl. No.: 13/264,412

(22) PCT Filed: Apr. 16, 2010
(86) PCT No.: PCT/CN10/00515

§ 371 Date: Oct. 14, 2011

(30) Foreign Application Priority Data
Apr. 17, 2009 (CN) 2009 10082420.8
Aug. 21, 2009 (CN) 2009 10163055.3

(51) Int. Cl. C08F 4/656

(52) U.S. Cl. 526/123.1; 502/107; 502/127

(57) ABSTRACT

A process for preparing a solid particle-type catalyst component used for olefin polymerization which contains magnesium, titanium, a halogen and an electron donor as essential ingredients, a catalyst component obtained by said process, and a catalyst containing the catalyst component are disclosed.

### CROSS REFERENCE TO RELATED APPLICATIONS

The present application claims the benefit of the Chinese Patent Application No. 200910082420.8, filed on Apr. 17, 2009, and No. 200910163055.3, filed on Aug. 21, 2009, which are incorporated herein by reference in their entirety and for all purposes.

### FIELD OF THE INVENTION

The present invention relates to a process for the preparation of a catalyst component for olefin polymerization, a catalyst component obtained by said process, and a catalyst comprising the catalyst component, and more specifically to a process for the preparation of a solid particulate catalyst component for olefin polymerization comprising magnesium, titanium, a halogen and an internal electron donor as essential constituents, a catalyst component obtained by said process, and a catalyst comprising the catalyst component.

### BACKGROUND ART

One process for the preparation of a solid particulate catalyst for olefin polymerization containing magnesium, titanium, a halogen and an electron donor as essential constituents comprises preparing magnesium dichloride into a homogeneous solution, then precipitating particulate magnesium dichloride carrier by crystallization, and loading a titanium-containing active component thereon. In the course of the precipitation, the presence of a co-precipitant is generally required, to obtain solids having a homogeneous particle size. The co-precipitant is generally an organic anhydride, an organic acid, a ketone, an ether, a carboxylic ester, or the like.

CN85100997A discloses a titanium-containing catalyst component and a process for the preparation thereof. Said process comprises dissolving a magnesium halide in an organic epoxy compound and an organo phosphorus compound to form a homogeneous solution; combining the solution with a titanium tetrahalide or a derivate thereof, to precipitate solids in the presence of a co-precipitant, such as an organic anhydride; and treating the solids with a polycarboxylic ester, and then with a mixture of a titanium tetrahalide and an inert diluent, to obtain the titanium-containing catalyst component.

CN1436766A discloses an ester of polyol, which is useful in the preparation of a catalyst for olefin polymerization. Both CN1436796A and CN1453298A describe active components of polyolefin catalysts obtained by using such a specific ester of polyol as an internal electron donor, and said catalysts have higher activities and better stereospecific property. In said patent applications, the ester of polyol is supported on a surface of a particulate catalyst carrier after the catalyst carrier has been formed, and the amount of the ester of diol is relatively large.

Although a number of catalysts for olefin polymerization have been disclosed in the prior art, there is still a need for a catalyst for olefin polymerization having good combined performance.

### SUMMARY OF THE INVENTION

The inventors have found by a number of experiments that in the preparation of a catalyst component for olefin polymerization, by using an ester of polyol having a specific structure or a combination of the ester of polyol and an organic silane as co-precipitant, it is possible to effectively control the precipitation of catalyst component particles, and thereby to obtain at a high yield a catalyst component having good particle morphology and narrow particle size distribution, which catalyst component, when used together with a cocatalyst in olefin polymerization, exhibits a high catalytic activity, a good hydrogen response property, a good stereospecific property, and good kinetic behavior, and gives a polymer having less fines.

Thus, an object of the invention is to provide a process for the preparation of a catalyst component for olefin polymerization.

A further object of the invention is to provide a catalyst component obtained by the process according to the invention.

A still further object of the invention is to provide a catalyst, comprising a reaction product of (1) the catalyst component according to the invention; (2) an alkyl aluminum compound; and (3) optionally, an external electron donor compound.

A still further object of the invention is to provide a process for polymerizing olefin, comprising contacting an olefin of formula CH₂═CHR, wherein R is H or an alkyl having 1 to 6 carbon atoms, optionally another kind of said olefin as comonomer, and optionally a diene as a second comonomer, with the catalyst of the invention wider polymerization conditions; and recovering the resulting polymer.

### DETAILED DESCRIPTION OF PREFERRED EMBODIMENTS

The term “polymerization” as used herein intends to encompass homopolymerization and copolymerization. The term “polymer” as used herein intends to encompass homopolymer, copolymer and terpolymer.

As used herein, the term “catalyst component” intends to means main catalyst component or procatalyst, which, together with a conventional cocatalyst such as an alkyl aluminum and an optional external electron donor, constitutes the catalyst for olefin polymerization.

In a first aspect, the present invention provides a process for the preparation of a catalyst component for olefin polymerization, comprising the steps of

(1) dissolving a magnesium halide in a solvent system to form a homogeneous solution, and optionally, adding an internal electron donor compound C thereto before, during, or after the dissolving;

(2) combining a titanium compound and a co-precipitant with the solution from step (1) to form a mixture;

(3) slowly heating (for example, over about 0.5 to 3 hours) the mixture from step (2) to a temperature of from 60 to 110° C., with an internal electron donor compound D being optionally added during or after the heating, and upon the temperature being reached, stirring the mixture for 0.5 to 8 hours, then removing the mother liquid through filtration, and washing the residual solids with an inert solvent to obtain magnesium- and titanium-containing solids; and

(4) treating the magnesium- and titanium-containing solids from step (3) with a titanium compound and an optional internal electron donor compound E in an inert solvent one or more times, then washing the solids with an inert solvent to obtain a solid catalyst component;

wherein the co-precipitant is co-precipitant A or a combination of co-precipitant A and co-precipitant B, the co-precipitant A is at least one ester of diol represented by general formula (I):

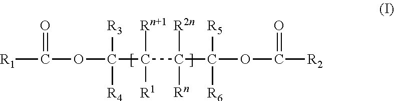

wherein R₁ to R₆ and R¹ to R^{2a} are independently chosen from hydrogen, halogen, optionally substituted linear or branched C₁-C₂₀ alkyl, C₃-C₂₀ cycloalkyl, C₆-C₂₀ aryl, C₇-C₂₀ alkaryl, C₇-C₂₀ aralkyl, C₂-C₁₀ alkenyl, and C₁₀-C₂₀ fused aryl, with the proviso that R₁ and R₂ are not hydrogen; one or more of R₃ to R₆ and R¹ and R²ⁿ are optionally linked to form a ring, and n is an integer ranging from 0 to 10,

the co-precipitant B is at least one organic silane represented by general formula (II): R^{I}ₐR^{II}_{b}Si(OR^{III})_{c}, wherein R^{I} and R^{II} are independently chosen from hydrogen, halogen, optionally substituted linear or branched C₁ to C₁₀ alkyl, C₂ to C₁₀ alkenyl, C₃ to C₁₀ cycloalkyl, C₆ to C₁₀ aryl, and heteroaryl having 3 to 10 carbon atoms and 1 to 3 heteroatoms chosen from N, O and S; R^{III} is independently chosen from C₁ to C₁₀ alkyl, C₃ to C₁₀ cycloalkyl and C₆ to C₁₀ aryl; and wherein a and b are independently an integer of from 0 to 4, c is an integer of from 0 to 4, and (a+b+c)=4.

The esters of diols useful as the co-precipitant A are disclosed in, for example, Chinese patent application CN1436766A and CN1436796A, the relevant contents of which are incorporated herein by reference.

Preferred compounds useful as the co-precipitant A are those represented by general formula (III):

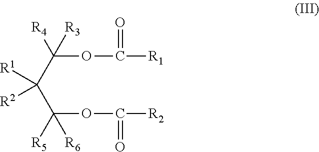

wherein R₁ to R₆ and R^{I}-R² groups are as defined for the general formula (I).

Examples include, but are not limited to, 2-ethyl-1,3-propandiol dibenzoate, 2-propyl-1,3-propandiol dibenzoate, 2-isopropyl-2-isoamyl-1,3-propandiol dibenzoate, 1,3-butandiol di-methylbenzoate, 2-methyl-1,3-butandiol di-m-chlorobenzoate, 2,3-dimethyl-1,3-butandiol dibenzoate, 1,3-pentandiol dipivalate, 2,4-pentandiol dibenzoate, 2,2-dimethyl-1,3-pentandiol dibenzoate, 2,4-heptandiol dibenzoate, 2-methyl-3,5-heptandiol dibenzoate, 2,3-diisopropyl-1,4-butandiol dibenzoate, 3,5-heptandiol dibenzoate, 4-ethyl-3,5-heptandiol dibenzoate, with 2,4-pentandiol dibenzoate, 3,5-heptandiol dibenzoate, and 4-ethyl-3,5-heptandiol dibenzoate being preferred.

Preferably, in the formula (II), R^{I} and R^{II} are independently chosen from C₁ to C₈ alkyl, C₃ to C₆ cycloalkyl, and C₆ to C₁₀ aryl, and R^{III} is a C₁ to C₁₀ alkyl.

Examples of the organic silane of the general formula (II): R^{I}ₐR^{II}_{b}Si(OR^{III})_{c} useful as the co-precipitant B include, but are not limited to, tetraethoxy silane, methyl cyclohexyl dimethoxy silane, diphenyl dimethoxy silane, methyl tert-butyl dimethoxy silane, dicyclopentyl dimethoxy silane, diisopropyl dimethoxy silane, diisobutyl dimethoxy silane, 2-ethylpiperidino tert-butyl dimethoxy silane, 1,1,1-trifluoro-2-propyl 2-ethylpiperidino dimethoxy silane, 1,1,1-trifluoro-2-propyl methyl dimethoxy silane, trimethyl methoxy silane, trimethyl ethoxy silane, trimethyl phenoxy silane, dimethyl dimethoxy silane, dimethyl diethoxy silane, methyl tert-butyl dimethoxy silane, diphenyl diethoxy silane, phenyl trimethoxy silane, phenyl triethoxy silane, vinyl trimethoxy silane, with tetraethoxy silane, methyl cyclohexyl dimethoxy silane, diphenyl dimethoxy silane, dicyclopentyl dimethoxy silane, diisopropyl dimethoxy silane, and diisobutyl dimethoxy silane being preferred.

Relative to one mole of magnesium halide, the amount of the co-precipitant A used ranges from 0.001 to 0.3 moles, and preferably from 0.01 to 0.1 moles, and the amount of the co-precipitant B used ranges from 0 to 0.5 moles, preferably from 0.01 to 0.5 moles, and more preferably from 0.01 to 0.3 moles.

The magnesium halide is chosen from magnesium dihalides, water or alcohol complexes of magnesium dihalides, derivatives of magnesium dihalides wherein one halogen atom in the magnesium dihalides is replaced with an alkoxy or a halogenated alkoxy, and mixtures thereof, and preferably from magnesium dihalides and alcohol complexes of magnesium dihalides. The specific examples include, but are not limited to, magnesium dichloride, magnesium dibromide, magnesium diiodide, and alcohol complexes thereof.

In an embodiment, the solvent system used in step (1) consists of an organic epoxy compound, an organo phosphorus compound and an optional inert diluent.

The organic epoxy compound comprises at least one of aliphatic epoxy compounds and diepoxy compounds, halogenated aliphatic epoxy compounds and diepoxy compounds, glycidyl ether, and inner ethers, having from 2 to 8 carbon atoms. Examples include, but are not limited to, epoxy ethane, epoxy propane, epoxy butane, vinyl epoxy ethane, butadiene dioxide, epoxy chloropropane, glycidyl methyl ether, and diglycidyl ether, with epoxy chloropropane being preferred.

The organo phosphorus compound comprises at least one of hydrocarbyl esters of orthophosphoric acid, halogenated hydrocarbyl esters of orthophosphoric acid, hydrocarbyl esters of phosphorous acid, and halogenated hydrocarbyl esters of phosphorous acid. Examples include, but are not limited to, trimethyl orthophosphate, triethyl orthophosphate, tributyl orthophosphate, triphenyl orthophosphate, trimethyl phosphite, triethyl phosphite, tributyl phosphite and tribenzyl phosphate, with tributyl orthophosphate being preferred.

Relative to one mole of the magnesium halide, the amount of the organic epoxy compound used ranges from 0.2 to 10 moles, and preferably from 0.5 to 4 moles, and the amount of the organo phosphorus compound used ranges from 0.1 to 3 moles, and preferably from 0.3 to 1.5 moles.

The optional inert diluent may be chosen from hexane, heptane, octane, decane, benzene, toluene, xylene, 1,2-dichloroethane, chlorobenzene, and other hydrocarbon and halogenated hydrocarbon solvents, as long as it can facilitate the dissolution of the magnesium halide. These inert diluents may be used alone or in combination. The amount of the inert diluent, if used, is not particularly crucial, however, it preferably ranges from 0.1 to 10 liters per mole of the magnesium halide, and preferably from 0.2 to 5 liters per mole of the magnesium halide.

In another embodiment, the solvent system used in step (1) consists of an alcohol compound and an optional inert diluent.

The alcohol compound is chosen from linear or branched aliphatic alcohol having 1 to 10 carbon atoms, cycloaliphatic alcohol having 3 to 12 carbon atoms, alkaryl alcohol having 6 to 20 carbon atoms, aralkyl alcohol having 6 to 20 carbon atoms, and mixtures thereof. Examples include, but are not limited to, ethanol, propanol, butanol, 2-ethylhexanol, benzyl alcohol, phenethyl alcohol. 2-Ethylhexanol is preferred. The amount of the alcohol used ranges from 2.0 to 6.0 moles, preferably from 2.0 to 4.5 moles, and more preferably from 2.5 to 3.5 moles, relative to one mole of the magnesium halide.

The optional inert diluent may be chosen from hexane, heptane, octane, decane, benzene, toluene, xylene, 1,2-dichloroethane, chlorobenzene, and other hydrocarbon and halogenated hydrocarbon solvents, as long as it can facilitate the dissolution of the magnesium halide. These inert diluents may be used alone or in combination. The amount of the inert diluent, if used, is not particularly crucial, however, it may range from 0.1 to 5 liters per mole of the magnesium halide.

In step (1), dissolution temperature can be easily determined by a person ordinarily skilled in the art depending on the solvent selected and the amount of the solvent used. In general, dissolution temperature may be between 10° C. and 150° C., and preferably between 50° C. and 120° C., and the upper limit of the temperature is generally not higher than the boiling point of the solvent.

In an embodiment, step (2) is carried out as follows: at a temperature of from −30° C. to 60° C., and preferably from −30° C. to 5° C., a titanium compound is combined with the solution from step (1), and then a co-precipitant is added thereto to form a mixture; alternatively, a co-precipitant is added to the solution from (1), and then at a temperature of from −30° C. to 60° C., and preferably from −30° C. to 5° C., the solution is combined with a titanium compound to form a mixture.

The internal electron donor compounds C, D, and E are independently chosen from the esters of diol represented by the general formula (I), alkyl esters of aliphatic or aromatic mono-basic carboxylic acids, alkyl esters of aliphatic or aromatic poly-basic carboxylic acids, aliphatic ethers, cycloaliphatic ethers, aliphatic katones, and mixtures thereof. The preferred includes esters of aliphatic dibasic carboxylic acids, esters of aromatic dibasic carboxylic acids, and diethers. The more preferred includes phthalates, malonates, succinates, glutarates, pivalates, adipates, sebacates, maleates, naphthalene dicarboxylates, trimellitates, benzene-1,2,3-tricarboxylates, pyromellitates and carbonates. Examples include, but are not limited to, diethyl phthalate, di-iso-butyl phthalate, di-n-butyl phthalate, di-iso-octyl phthalate, di-n-octyl phthalate, diethyl malonate, dibutyl malonate, diethyl 2,3-di-iso-propylsuccinate, di-iso-butyl 2,3-di-iso-propylsuccinate, di-n-butyl 2,3-diisopropylsuccinate, dimethyl 2,3-di-iso-propylsuccinate, di-iso-butyl 2,2-dimethylsuccinate, di-iso-butyl 2-ethyl-2-methylsuccinate, diethyl 2-ehtyl-2-methylsuccinate, diethyl adipate, dibutyl adipate, diethyl sebacate, dibutyl sebacate, diethyl maleate, di-n-butyl maleate, diethyl naphthalene dicarboxylate, dibutyl naphthalene dicarboxylate, triethyl trimellitate, tributyl trimellitate, triethyl benzene-1,2,3-tricarboxylate, tributyl benzene-1,2,3-tricarboxylate, tetraethyl pyromellitate, and tetrabutyl pyromellitate. By selecting different internal electron donor, the catalyst may exhibit different stereospecific property and hydrogen response property.

Relative to one mole of the magnesium halide, the amount of the electron donor compound C used ranges from 0 to 3 moles, and preferably from 0 to 0.3 moles, the amount of the electron donor compound D plus E used ranges from 0 to 5 moles, and preferably from 0 to 1 mole, and the amount of the electron donor compound C+D+E used ranges from 0 to 5 moles, and preferably from 0.02 to 1 mole.

The titanium compound used in step (2) and the titanium compound used in step (4) may be the same or different, and they have a general formula: TiXₙ(OR)₄₋ₙ, in which R is independently a C₁-C₂₀ hydrocarbyl group, X is independently a halogen, and n=1 to 4. Examples include, but are not limited to, titanium tetrachloride, titanium tetrabromide, titanium tetraiodide, tetrabutoxy titanium, tetraethoxy titanium, triethoxy titanium chloride, diethoxy titanium dichloride, ethoxy titanium trichloride, and mixtures thereof, with titanium tetrachloride being preferred. Conveniently, the same titanium compound is used in step (2) and in step (4). Relative to one mole of the magnesium halide, the amount of the titanium compound used in step (2) ranges from 1.5 to 50 moles, and preferably from 4 to 30 moles, and the amount of the total titanium compound used in step (2) and step (4) ranges from 2 to 150 moles, and preferably from 5 to 60 moles.

The inert solvent used in step (3) and the inert solvent used in step (4) are independently chosen from hexane, heptane, octane, decane, benzene, toluene, xylenes, and mixtures thereof.

Preferably, in step (1) of the process of the invention, a magnesium halide is dissolved in a solvent system consisting of an organic epoxy compound, an organo phosphorus compound and an inert diluent to form a homogeneous solution, and then the internal electron donor compound C is added thereto to form a homogeneous solution. The dissolution temperature may be between 10° C. and 150° C., and preferably between 50° C. and 120° C., and the upper limit of the temperature is generally not higher than the boiling point of the solvent.

Preferably, in step (2) of the process of the invention, the titanium compound is added dropwise to the solution from step (1) at a temperature of from −30° C. to 60° C., and then the co-precipitant A and the co-precipitant B are added thereto to form a mixture.

In a second aspect, the present invention provides a catalyst component obtained by the above-described process according to the invention. The catalyst component of the invention has good particle morphology and narrow particle size distribution.

In a third aspect, the present invention provides a catalyst for the polymerization of an olefin of formula CH₂═CHR, in which R is hydrogen or an alkyl having 1 to 6 carbon atoms, comprising a reaction product of the following components:

(1) the catalyst component according to the invention;

(2) an alkylaluminum compound as a cocatalyst; and

(3) optionally, an external electron-donor compound.

Alkyl aluminum compounds useful as cocatalyst are well known to a person skilled in the art. The alkyl aluminum compounds are preferably those represented by general formula AlRₙX₃₋ₙ, in which R is independently hydrogen or a C₁-C₂₀ hydrocarbon radical, and especially an alkyl, an aralkyl, or an aryl; X is independently a halogen, and especially chloride or bromide; and n has a value meeting 0<n≦3. Examples of the alkyl aluminum compound include, but are not limited to, trialkyl aluminums, such as trimethyl aluminum, triethyl aluminum, triisobutyl aluminum, trioctyl aluminum; alkyl aluminum hydrides, such as diethyl aluminum hydride, diisobutyl aluminum hydride; and alkyl aluminum chlorides, such as diethyl aluminum chloride, di-isobutyl aluminum chloride, ethyl aluminum sesquichloride, ethyl aluminum dichloride, with triethyl aluminum and triisobutyl aluminum being preferred.

The alkyl aluminum compound is used in such an amount that a molar ratio of aluminum therein to titanium in the solid catalyst component (1) ranges from 5 to 5000, and preferably from 20 to 500.

The external electron donor compound may be one of those well-known by a person skilled in the art. Preferred external electron donor compounds useful in the invention include organic silicon compounds of general formula RₙSi(OR′)₄₋ₙ, wherein 0<n≦3, R and R′ are independently chosen from optionally halogenated C₁-C₂₀ alkyl, C₂-C₂₀ alkenyl, C₃-C₂₀ cycloalkyl, C₆-C₂₀ aryl, and heteroaryl having 3 to 10 carbon atoms and 1 to 3 heteroatoms chosen from N, O and S, and R may also be a halogen or hydrogen. Examples of the organic silicon compound include, but are not limited to, trimethyl methoxy silane, trimethyl ethoxy silane, trimethyl phenoxy silane, dimethyl dimethoxy silane, dimethyl diethoxy silane, methyl tert-butyl dimethoxy silane, diphenyl dimethoxy silane, diphenyl diethoxy silane, phenyl trimethoxy silane, phenyl triethoxy silane, vinyl trimethoxy silane, cyclohexyl methyl dimethoxy silane, dicyclopentyl dimethoxy silane, 2-ethylpiperidino tert-butyl dimethoxy silane, 1,1,1-trifluoro-2-propyl 2-ethylpiperidino dimethoxy silane and 1,1,1-trifluoro-2-propyl methyl dimethoxy silane.

If used, the external electron donor compound is used in such an amount that a molar ratio of the alkyl aluminum compound to the external electron donor compound ranges from 0.1 to 500, preferably from 1 to 300, and more preferably from 3 to 100.

The component (2) and the optional component (3) can contact and react with the active catalyst component (1) separately or as a mixture.

The above-described catalysts are useful in the polymerization of olefin CH₂═CHR (wherein R is H or an alkyl having 1 to 6 carbon atoms) or a feed containing said olefin and a small amount of diene, if necessary.

Thus, in another aspect, the present invention relates to a process for polymerizing olefin, comprising contacting an olefin of a formula CH₂═CHR, wherein R is H or an alkyl having 1 to 6 carbon atoms, optionally another kind of said olefin as a comonomer, and optionally a diene as a second comonomer, with the catalyst of the invention under polymerization conditions; and recovering the resulting polymer.

The polymerization of olefin(s) may be carried out in liquid phase of liquid monomer or a solution of monomer in an inert solvent, or in gas phase, or in a combination of gas phase and liquid phase, according the known processes. The polymerization is generally carried out at a temperature of from 0° C. to 150° C., and preferably from 60° C. to 100° C., and at normal or higher pressure. In the polymerization, hydrogen as a regulator of polymer molecular weight may be added to the polymerization reactor to adjust the molecular weight and melt index of a polymer.

In the present process for the preparation of a catalyst component, an ester of polyol having a specific structure or a combination of the ester of polyol and an organic silane is used as co-precipitant in place of the conventional co-precipitant such as phthalic anhydride. Compared with the process for the preparation of a catalyst disclosed in patent application CN1453298A, the present process omits the use of phthalic anhydride, and uses an ester of polyol in a reduced amount. Furthermore, by altering the order of the additions of materials and adjusting the formulation of the dissolution, the present process obtains at a high yield catalyst components having good particle morphology. When used in propylene polymerization, the catalyst components exhibit higher catalytic activities and desired kinetic behavior, and give polymers having less fines.

### EXAMPLES

The following examples are provided to further illustrate the present invention and by no means intend to limit the scope thereof.

### Testing Methods:

1. Titanium content of a catalyst: measured on a Spectrophotometer, model 721.

2. Particle size distribution of a catalyst: measured through a laser diffraction method in n-hexane dispersant on a Malvem Model 2000 instrument.

3. Melt index of a polymer: measured according to GB/T3682-2000.

4. Isotacticity of a polymer: measured by heptane extraction method carried out as follows: 2 g of dry polymer sample is extracted with boiling heptane in an extractor for 6 hours, then the residual substance is dried to constant weight, and the ratio of the weight of the residual polymer (g) to 2 (g) is regarded as isotacticity.

5. Molecular weight distribution of a polymer, MWD (MWD=Mw/Mn): measured on PL-GPC220, solvent: trichlorobenzene, temperature: 150° C., Standard sample: polystyrene, flow rate: 1.0 ml/min, column: 3×Plgel 10 μm MlxED-B 300×7.5 nm.

### I. Preparation of Solid Catalyst Components

### Example 1

To a reactor, in which air had been repeatedly replaced with high pure N₂, were charged successively 0.05 moles of anhydrous magnesium dichloride, 0.75 moles of toluene, 0.1 moles of epoxy chloropropane, and 0.033 moles of tributyl phosphate. The reaction mixture was stirred at a stirring speed of 450 rpm at a temperature of 60° C. for 1.5 hours. To the reactor was added 1.9 mmol of dibutyl phthalate, and the reaction mixture was allowed to react for 1 hour, and then cooled to −28° C. 0.51 Moles of TiCl₄ were added dropwise thereto, followed by the addition of 1.4 mmol of 3,5-heptandiol dibenzoate and 4.4 mmol of diphenyl dimethoxy silane in 0.1 moles of toluene. The reaction mixture was allowed to react for 1 hour. Then the mixture was heated slowly to 85° C. over 2 hours, and particulate solids precipitated during the heating. After the temperature reached 85° C., 2.6 mmol of dibutyl phthalate was added. The reaction mixture was maintained at that temperature for 1 hour, and then the mother liquid was filtered off. The residual solids were washed with toluene twice. 0.44 Moles of titanium tetrachloride and 0.7 moles of toluene were added thereto, the reaction mixture was stirred at 110° C. for 2 hours, and then the mother liquid was filtered off. The titanium tetrachloride treatment was repeated twice. The solids were washed with hexane five times and dried under vacuum, to give a solid titanium-containing catalyst component.

### Example 2

To a reactor, in which air had been repeatedly replaced with high pure N₂, were charged successively 0.05 moles of anhydrous magnesium dichloride, 0.75 moles of toluene, 0.1 moles of epoxy chloropropane, and 0.033 moles of tributyl phosphate. The reaction mixture was stirred at a stirring speed of 450 rpm at a temperature of 60° C. for 1.5 hours. To the reactor was added 1.9 mmol of dibutyl phthalate, and the reaction mixture was allowed to react for 1 hour, and then cooled to −28° C. 0.51 Moles of TiCl₄ were added dropwise thereto, followed by the addition of 1.4 mmol of 3,5-heptandiol dibenzoate and 4.4 mmol of diphenyl dimethoxy silane in 0.1 moles of toluene. The reaction mixture was allowed to react for 1 hour. Then the mixture was heated slowly to 85° C. over 2 hours, and particulate solids precipitated during the heating. After the temperature reached 85° C., the reaction mixture was maintained at that temperature for 1 hour, and then the mother liquid was filtered off. The residual solids were washed with toluene twice. 0.44 Moles of titanium tetrachloride and 0.7 moles of toluene were added thereto, and the contents were heated to 110° C., with 2.6 mmol of dibutyl phthalate being added thereto in the course of heating. The contents were stirred at 110° C. for 1 hour, and then the mother liquid was filtered off. The solids were treated with 0.44 moles of titanium tetrachloride and 0.7 moles of toluene twice, washed with hexane five times, and dried under vacuum, to give a solid titanium-containing catalyst component.

### Example 3

To a reactor, in which air had been repeatedly replaced with high pure N₂, were charged successively 0.05 moles of anhydrous magnesium dichloride, 0.75 moles of toluene, 0.1 moles of epoxy chloropropane, and 0.033 moles of tributyl phosphate. The reaction mixture was stirred at a stirring speed of 450 rpm at a temperature of 60° C. for 2.5 hours, and then cooled to −28° C. 0.51 Moles of TiCl₄ were added dropwise thereto, followed by the addition of 2.0 mmol of 4-ethyl-3,5-heptandiol dibenzoate and 4.4 mmol of diphenyl dimethoxy silane in 0.1 moles of toluene. The reaction mixture was allowed to react for 1 hour. Then the mixture was heated slowly to 85° C. over 2 hours, and particulate solids precipitated during the heating. After the temperature reached 85° C., 4.5 mmol of dibutyl phthalate was added. The reaction mixture was maintained at that temperature for 1 hour, and then the mother liquid was filtered off. The residual solids were washed with toluene twice, and then treated with 0.44 moles of titanium tetrachloride and 0.7 moles of toluene at 110° C. for 1 hour. The titanium tetrachloride treatment was repeated twice. The residual solids were washed with hexane five times and dried under vacuum, to give a solid titanium-containing catalyst component.

### Example 4

To a reactor, in which air had been repeatedly replaced with high pure N₂, were charged successively 0.05 moles of anhydrous magnesium dichloride, 0.75 moles of toluene, 0.1 moles of epoxy chloropropane, and 0.033 moles of tributyl phosphate. The reaction mixture was stirred at a stirring speed of 450 rpm at a temperature of 60° C. for 1.5 hours. To the reactor was added 2.6 mmol of dibutyl phthalate, and the reaction mixture was allowed to react for 1 hour, and then cooled to −28° C. 0.51 Moles of TiCl₄ were added dropwise thereto, followed by the addition of 1.9 mmol of 2,4-pentandiol dibenzoate and 8.8 mmol of diphenyl dimethoxy silane in 0.17 moles of toluene. The reaction mixture was allowed to react for 1 hour. Then the mixture was heated slowly to 85° C. over 2 hours, and particulate solids precipitated during the heating. After the temperature reached 85° C., 1.1 mmol of dibutyl phthalate was added. The reaction mixture was maintained at that temperature for 1 hour, and then the mother liquid was filtered off. The residual solids were washed with toluene twice, and then treated with 0.44 moles of titanium tetrachloride and 0.7 moles of toluene at 110° C. for 1 hour. The titanium tetrachloride treatment was repeated twice. Then the residual solids were washed with hexane five times and dried under vacuum, to give a solid titanium-containing catalyst component.

### Example 5

Example 4 was repeated, except that the 8.8 mmol of diphenyl dimethoxy silane was replaced with 7.5 mmol of diisopropyl dimethoxy silane.

### Example 6

Example 4 was repeated, except that the 8.8 mmol of diphenyl dimethoxy silane was replaced with 9.0 mmol of tetraethoxy silane.

### Example 7

Example 3 was repeated, except that the 4.4 mmol of diphenyl dimethoxy silane was omitted.

### Example 8

Example 3 was repeated, except that the addition of 4.5 mmol of dibutyl phthalate at 85° C. was replaced with addition of 2.4 mmol of 4-ethyl-3,5-heptandiol dibenzoate at 85° C.

### Example 9

To a reactor, in which air had been repeatedly replaced with high pure N₂, were charged successively 0.05 moles of anhydrous magnesium dichloride, 0.28 moles of toluene, and 0.14 moles of 2-ethylhexanol. The reaction mixture was stirred at a stirring speed of 450 rpm at a temperature of 95° C. for 3 hours, to form a homogeneous solution of alcohol adduct. 1.4 Mmol of 3,5-heptandiol dibenzoate and 4.4 mmol of diphenyl dimethoxy silane were added thereto, and the reaction mixture was stirred for 30min and then cooled to room temperature.

The above-prepared solution was transferred to a reactor, in which air had been repeatedly replaced with high pure N₂, containing 0.55 moles of TiCl₄ and 0.66 moles of toluene at −20° C., and the resultant mixture was stirred at −20° C. for 5 hours. Then the reaction mixture was heated slowly to 110° C. over 2 hours, 4.5 mmol of diisobutyl phthalate was added thereto, and the reaction was allowed to continue for 1 hour. Upon the completion of the reaction, the liquid was filtered off. To the reactor were added 0.44 moles of titanium tetrachloride and 0.66 moles of toluene, and the mixture was stirred at 110° C. for 1 hour, and then the liquid was filtered off. Again, to the reactor were added 0.44 moles of titanium tetrachloride and 0.66 moles of toluene, and the mixture was stirred at 110° C. for 1 hour, and then the liquid was filtered off. The residues were washed with hexane five times and dried, to give a solid titanium-containing catalyst component.

### Example 10

To a reactor, in which air had been repeatedly replaced with high pure N₂, were charged successively 0.05 moles of anhydrous magnesium dichloride, 0.28 moles of toluene, and 0.14 moles of 2-ethylhexanol. The reaction mixture was stirred at a stirring speed of 450 rpm at a temperature of 95° C. for 3 hours, to form a homogeneous solution of alcohol adduct. Then the solution was cooled to room temperature.

The above-prepared alcohol adduct solution was transferred to a reactor, in which air had been repeatedly replaced with high pure N₂, containing 0.55 moles of TiCl₄ and 0.66 moles of toluene at −20° C., and the resultant mixture was stirred at −20° C. for 30 min. Then 1.4 mmol of 3,5-heptandiol dibenzoate and 4.4 mmol of diphenyl dimethoxy silane were added thereto, and the reaction mixture was stirred for further 5 hours. Then the reaction mixture was heated slowly to 110° C. over 2 hours, 4.5 mmol of diisobutyl phthalate was added thereto, and the reaction was allowed to continue for 1 hour. Upon the completion of the reaction, the liquid was filtered off. To the reactor were added 0.44 moles of titanium tetrachloride and 0.66 moles of toluene, and the mixture was stirred at 110° C. for 1 hour, and then the liquid was filtered off. Again, to the reactor were added 0.44 moles of titanium tetrachloride and 0.66 moles of toluene, and the mixture was stirred at 110° C. for 1 hour, and then the liquid was filtered off. The residual solids were washed with hexane five times and dried, to give a solid titanium-containing catalyst component.

### Comparative Example 1

To a reactor, in which air had been repeatedly replaced with high pure N₂, were charged successively 0.05 moles of anhydrous magnesium dichloride, 0.88 moles of toluene, 0.05 moles of epoxy chloropropane, and 12.5 ml of tributyl phosphate. The reaction mixture was stirred at a stirring speed of 450 rpm at a temperature of 60° C. for 2 hours. To the reactor was added 0.01 moles of phthalic anhydride, and the reaction mixture was allowed to react for 1 hour, and then cooled to −28° C. 0.51 Moles of TiCl₄ were added dropwise thereto, and the temperature was raised slowly to 85° C., with 8.0 mmol of dibutyl phthalate being added when the temperature reached 80° C. After the temperature reached 85° C., the reaction mixture was maintained at that temperature for 1 hour, and then the mother liquid was filtered off. The residual solids were washed with 0.95 moles of toluene twice, and then treated with 0.36 moles of titanium tetrachloride and 0.57 moles of toluene at 110° C. for 2 hours, and then the liquid was filtered off The titanium tetrachloride treatment was repeated once. The resultant solids were washed with hexane five times and dried, to give a solid titanium-containing catalyst component.

### Comparative Example 2

Example 4 was repeated, except that the 1.9 mmol of 2,4-pentandiol dibenzoate was omitted. In the course of heating to 85° C., particulate solids precipitated, but the solids were very fine and did not settled so that no solid titanium-containing catalyst component could be obtained.

### Comparative Example 3

To a reactor, in which air had been repeatedly replaced with high pure N₂, were charged successively 0.05 moles of anhydrous magnesium dichloride, 0.9 moles of toluene, 0.05 moles of epoxy chloropropane, and 0.046 moles of tributyl phosphate. The reaction mixture was stirred at a stirring speed of 450 rpm at a temperature of 60° C. for 2 hours. To the reactor was added 0.01 moles of phthalic anhydride, and the contents were allowed to react for 1 hour, and then cooled to −28° C. 0.51 Moles of TiCl₄ were added dropwise thereto, and the mixture was heated slowly to 85° C. over 2 hours, with 5.0 mmol of 4-ethyl-3,5-heptandiol dibenzoate being added when the temperature reached 75° C. After the temperature reached 85° C., the reaction mixture was maintained at that temperature for 1 hour, and then the mother liquid was filtered off. The residual solids were washed with 0.95 moles of toluene twice, and then treated with 0.36 moles of titanium tetrachloride and 0.57 moles of toluene at 110° C. for 2 hours, and then the liquid was filtered off. The titanium tetrachloride treatment was repeated once. The resultant solids were washed with hexane five times and dried, to give a solid titanium-containing catalyst component.

### Comparative Example 4

To a reactor, in which air had been repeatedly replaced with high pure N₂, were charged successively 0.05 moles of anhydrous magnesium dichloride, 0.11 moles of decane, and 0.15 moles of 2-ethylhexanol. The contents were stirred at a stirring speed of 450 rpm at a temperature of 130° C. for 2 hours, and 8.1 mmol of phthalic anhydride was added thereto. The reaction was allowed to continue for 1 hour, to form a homogeneous solution of alcohol adduct. Then the solution was cooled to room temperature.

The above-prepared homogeneous solution of alcohol adduct was transferred to a reactor, in which air had been repeatedly replaced with high pure N₂, containing 1.3 moles of TiCl₄ at −20° C., and the resultant mixture was stirred for 4 hours. Then the reaction mixture was heated to 110° C., 12.7 mmol of diisobutyl phthalate was added thereto, and the contents were stirred for further 2 hours. Upon the completion of the reaction, the liquid was filtered off. To the reactor were added 1.6 moles of titanium tetrachloride, and the mixture was stirred at 110° C. for 2 hours, and then the liquid was filtered off. The residual solids were washed with hexane five times and dried, to give a solid titanium-containing catalyst component.

### Comparative Example 5

Comparative Example 4 was repeated, except that the 12.7 mmol of diisobutyl phthalate was replaced with 12.7 mmol of 4-ethyl-3,5-heptandiol dibenzoate.

### II. Propylene Polymerization

At room temperature, to a 5 L autoclave, in which air had been completely replaced with gaseous propylene, were added 5 ml of a 0.5 M solution of triethyl aluminum in hexane, 1 ml of a 0.11 M solution of cyclohexyl methyl dimethoxy silane (CHMMS) in hexane, and 10 mg of a solid catalyst component suspended in 10 ml of hexane. Then to the autoclave were introduced 1.0 liters (standard volume) of hydrogen gas and 1.15 Kg of liquid propylene, and the contents were heated to 70° C. within 10 min with stirring. Polymerization was allowed to continue for a period of time at 70° C. The results are shown in Table 2 below.

TABLE 1-1
Results of catalyst components

| | Yield* | Ti | Particle size distribution of catalyst component | | | |
|---|---|---|---|---|---|---|
| Item | % | % | d(0.1) | d(0.5) | d(0.9) | Span |
| Exam- | 131.2 | 2.64 | 19.2 | 26.6 | 37.1 | 0.67 |
| ple 1 | | | | | | |
| Exam- | 143.1 | 2.52 | 14.5 | 24.1 | 34.0 | 0.81 |
| ple 2 | | | | | | |
| Exam- | 148 | 2.57 | 14.2 | 20.7 | 30.3 | 0.78 |
| ple 3 | | | | | | |
| Comp. | 124 | 2.13 | 11.6 | 22.6 | 37.6 | 1.15 |
| Ex. 1 | | | | | | |

*Yield was calculated according to the following equation:
Yield of catalyst component % = mass of the obtained catalyst component/mass of the magnesium dichloride used × 100%

It can be seen from the data shown in Table 1-1 that, compared with the catalyst component obtained by a process using phthalic anhydride as co-precipitant, the catalyst components prepared by the process of the invention have higher yields, better adjustability of particle size, and narrower particle size distribution.

TABLE 2-1
Propylene polymerization results

| | Activity | Activity | | | | | |
|---|---|---|---|---|---|---|---|
| | for 1 h | for 2 h | BD | MI | | | Polymer |
| | kgPP/ | kgPP/ | g/ | g/10 | II | | fines <0.18 |
| Item | gCat | gCat | cm³ | min | % | MWD | mm |
| Exam- | 49.2 | 84.1 | 0.47 | 3.87 | 97.9 | 6.3 | 0.4% |
| ple 1 | | | | | | | |
| Exam- | 43.1 | 68.3 | 0.47 | 3.08 | 98.0 | 6.6 | 0.4% |
| ple 2 | | | | | | | |
| Exam- | 49.0 | 81.2 | 0.45 | 3.86 | 98.1 | 6.5 | 0.2% |
| ple 3 | | | | | | | |
| Comp. | 29.0 | 52.1 | 0.45 | 3.82 | 98.8 | 4.6 | 0.7% |
| Ex. 1 | | | | | | | |

It can be seen from the results shown in Table 2-1 that the catalyst components prepared by the process of the invention have higher polymerization activities, and the resulting polymers have less fines and good property with respect to isotacticity, melt index, bulk density, and molecular weight distribution.

TABLE 1-2
Results of catalyst components

| | Yield | Ti | Particle size distribution of catalyst component | | | |
|---|---|---|---|---|---|---|
| Item | % | % | d(0.1) | d(0.5) | d(0.9) | Span |
| Exam- | 130.8 | 2.69 | 13.7 | 19.3 | 27.4 | 0.71 |
| ple 4 | | | | | | |
| Exam- | 126.2 | 2.6 | 10.6 | 17.6 | 24.8 | 0.81 |
| ple 5 | | | | | | |
| Exam- | 145.6 | 3.19 | 17.6 | 28.5 | 40.3 | 0.79 |
| ple 6 | | | | | | |
| Exam- | 149 | 2.53 | 14.3 | 23.6 | 40.2 | 1.10 |
| ple 7 | | | | | | |
| Comp. | — | — | — | — | — | — |
| Ex. 2 | | | | | | |

It can be seen from the results shown in Table 1-2 that, by the present process for the preparation of a catalyst component, it is possible to obtain catalyst component products having different average particle size by using different combination of the ester of diol and the silane as co-precipitant. If the silane as the co-precipitant is omitted, the particle morphology of the catalyst component might be affected, and if the ester of diol as the co-precipitant is omitted, no catalyst component can be obtained.

TABLE 2-2
Propylene polymerization results

| | Activity | Activity | | | | | |
|---|---|---|---|---|---|---|---|
| | for 1 h | for 2 h | BD | MI | | | Polymer |
| | kgPP/ | kgPP/ | g/ | g/10 | II | | fines <0.18 |
| Item | gCat | gCat | cm³ | min | % | MWD | mm |
| Exam- | 50.2 | 86.7 | 0.46 | 3.22 | 98.2 | 6.5 | 0.2% |
| ple 4 | | | | | | | |
| Exam- | 43.5 | 68.1 | 0.47 | 1.79 | 99.1 | 6.3 | 0.3% |
| ple 5 | | | | | | | |
| Exam- | 52.1 | 90.5 | 0.47 | 2.4 | 98.5 | 6.2 | 0.5% |
| ple 6 | | | | | | | |
| Exam- | 45.8 | 75.2 | 0.45 | 3.81 | 98.0 | 6.4 | 0.1% |
| ple 7 | | | | | | | |
| Comp. | — | — | — | — | — | — | — |
| Ex. 2 | | | | | | | |

It can be seen from the results shown in Table 2-2 that, by the present process for the preparation of a catalyst component, it is possible to obtain catalyst components having good particle morphology, different hydrogen response property, and different isotacticity property by using different combination of the ester of diol and the silane as co-precipitant.

TABLE 1-3
Results of catalyst components

| | Yield | Ti | Particle size distribution of catalyst component | | | |
|---|---|---|---|---|---|---|
| Item | % | % | d(0.1) | d(0.5) | d(0.9) | Span |
| Exam- | 148 | 2.57 | 14.2 | 20.7 | 30.3 | 0.78 |
| ple 3 | | | | | | |
| Exam- | 147 | 3.15 | 15.3 | 23.6 | 36.2 | 0.88 |
| ple 8 | | | | | | |
| Comp. | 138 | 3.56 | 11.4 | 21.9 | 37.4 | 1.19 |
| Ex. 3 | | | | | | |

It can be seen from the results shown in Table 1-3 that the present process, which uses an ester of diol rather than phthalic anhydride as co-precipitant, may obtain catalyst components at higher yields, the amount of the ester of diol as co-precipitant is less, and the catalyst components have better adjustability of particle size and narrower particle size distribution.

TABLE 2-3
Propylene polymerization results

| | Activity | Activity | | | | | |
|---|---|---|---|---|---|---|---|
| | for 1 h | for 2 h | BD | MI | | | Polymer |
| | kgPP/ | kgPP/ | g/ | g/10 | II | | fines <0.18 |
| Item | gCat | gCat | cm³ | min | % | MWD | mm |
| Exam- | 49.0 | 81.2 | 0.45 | 3.86 | 98.1 | 6.5 | 0.2% |
| ple 3 | | | | | | | |
| Exam- | 47.5 | 79.1 | 0.46 | 3.15 | 98.4 | 7.1 | 0.3% |
| ple 8 | | | | | | | |
| Comp. | 48.2 | 63.5 | 0.45 | 2.55 | 98.3 | 7.5 | 0.4% |
| Ex. 3 | | | | | | | |

It can be seen from the data shown in Table 2-3 that, compared with the catalyst component obtained by using phthalic anhydride as co-precipitant and using an ester of diol as internal electron donor, the catalyst components of the invention have higher polymerization activities, and the activity declines more slowly.

TABLE 1-4
Results of catalyst components

| | Yield | Ti | Particle size distribution of catalyst component | | | |
|---|---|---|---|---|---|---|
| Item | % | % | d(0.1) | d(0.5) | d(0.9) | Span |
| Exam- | 135.1 | 2.81 | 17.4 | 27.0 | 43.7 | 0.97 |
| ple 9 | | | | | | |
| Exam- | 132.5 | 2.78 | 15.2 | 26.1 | 36.5 | 0.82 |
| ple 10 | | | | | | |
| Compar- | 126.1 | 2.39 | 15.6 | 26.7 | 38.7 | 0.76 |
| ative | | | | | | |
| Exam- | | | | | | |
| ple 4 | | | | | | |
| Comp. | 136.2 | 3.38 | 13.3 | 25.4 | 36.2 | 0.90 |
| Ex. 5 | | | | | | |

It can be seen from the data shown in Table 1-4 that, compared with the preparation process using phthalic anhydride as co-precipitant, the preparation process of the invention may obtain catalyst components having good particle morphology at higher yields.

TABLE 2-4
Propylene polymerization results

| | Activity | Activity | | | | | |
|---|---|---|---|---|---|---|---|
| | for 1 h | for 2 h | BD | MI | | | Polymer |
| | kgPP/ | kgPP/ | g/ | g/10 | II | | fines <0.18 |
| Item | gCat | gCat | cm³ | min | % | MWD | mm |
| Exam- | 48.6 | 84.3 | 0.45 | 2.64 | 98.0 | 6.7 | 0.2% |
| ple 9 | | | | | | | |
| Exam- | 49.2 | 86.3 | 0.45 | 2.37 | 98.5 | 6.3 | 0.3% |
| ple 10 | | | | | | | |
| Comp. | 29.6 | 51.7 | 0.46 | 5.12 | 97.3 | 5.1 | 0.3% |
| Ex. 4 | | | | | | | |
| Comp. | 46.2 | 61.9 | 0.45 | 3.21 | 98.2 | 6.9 | 0.4% |
| Ex. 5 | | | | | | | |

It can be seen from the data shown in Table 2-4 that the catalyst components prepared by the process of the invention have higher activities, with the activities declining more slowly, that the catalyst components have good property with respect to isotacticity, melt index, bulk density, and molecular weight distribution, and that the resultant polymers contain less fines.

The patents, patent applications and testing methods cited in the specification are incorporated herein by reference.

While the invention has been described with reference to exemplary embodiments, it will be understood by those skilled in the art that various changes and modifications may be made without departing from the spirit and scope of the invention. Therefore, the invention is not limited to the particular embodiments disclosed as the best mode contemplated for carrying out this invention, but the invention will include all embodiments falling within the scope of the appended claims.

What is claimed is:

1-12. (canceled)

13. A process for the preparation of a catalyst component for olefin polymerization, comprising the steps of:
(1) dissolving a magnesium halide in a solvent system to form a homogeneous solution, and optionally, adding an internal electron donor compound C thereto before, during, or after the dissolving;
(2) combining a titanium compound and a co-precipitant with the solution from step (1) to form a mixture;
(3) slowly heating the mixture from step (2) to a temperature of from 60 to 110° C., with an internal electron donor compound D being optionally added during or after the heating, and upon the temperature being reached, stirring the mixture for 0.5 to 8 hours, then removing the mother liquid through filtration, and washing the residual solids with an inert solvent to obtain magnesium- and titanium-containing solids; and
(4) treating the magnesium- and titanium-containing solids from step (3) with a titanium compound and an optional internal electron donor compound E in an inert solvent one or more times, and then washing the solids with an inert solvent to obtain a catalyst component;
wherein the co-precipitant is co-precipitant A or a combination of co-precipitant A and co-precipitant B, the co-precipitant A is at least one ester of diol represented by a general formula (I): 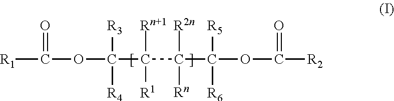
wherein R₁ to R₆ and R¹ to R²ⁿ are independently chosen from hydrogen, halogen, optionally substituted linear or branched C₁-C₂₀ alkyl, C₃-C₂₀ cycloalkyl, C₆-C₂₀ aryl, C₇-C₂₀ alkaryl, C₇-C₂₀ aralkyl, C₂-C₁₀ alkenyl, and C₁₀-C₂₀ fused aryl, with the proviso that R₁ and R₂ are not hydrogen; one or more of R₃ to R₆ and R¹ to R²ⁿ are optionally linked to form a ring; and n is an integer of from 0 to 10,
the co-precipitant B is at least one organic silane represented by a general formula (II): R^{I}ₐR^{II}_{b}Si(OR^{III})_{c}, wherein R^{I} and R^{II} are independently chosen from hydrogen, halogen, optionally substituted linear or branched C₁ to C₁₀ alkyl, C₂ to C₁₀ alkenyl, C₃ to C₁₀ cycloalkyl, C₆ to C₁₀ aryl, and heteroaryl having 3 to 10 carbon atoms and 1 to 3 heteroatoms chosen from N, O and S; R^{III} is independently chosen from C₁ to C₁₀ alkyl, C₃ to C₁₀ cycloalkyl and C₆ to C₁₀ aryl; and wherein a and b are independently an integer of from 0 to 4, c is an integer of from 0 to 4, and (a+b+c)=4.

14. The process of claim 13, wherein the co-precipitant A is chosen from esters of diol represented by a general formula (III): 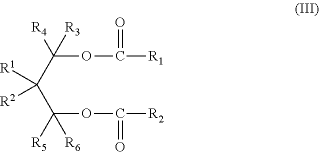
wherein R₁ to R₆ and R¹-R² are as defined for the general formula (I) in claim 13.

15. The process of claim 13, wherein in the formula (II), R^{I} and R^{II} are independently chosen from C₁ to C₈ alkyl, C₃ to C₆ cycloalkyl, and C₆ to C₁₀ aryl, and R^{III} is a C₁ to C₁₀ alkyl.

16. The process of claim 13, wherein the amount of the co-precipitant A used ranges from 0.001 to 0.3 moles, and the amount of the co-precipitant B used ranges from 0 to 0.5 moles, relative to one mole of the magnesium halide.

17. The process of claim 13, having at least one of the following features:
the magnesium halide is chosen from magnesium dihalides, water or alcohol complexes of magnesium dihalides, derivatives of magnesium dihalides wherein one halogen atom in the magnesium dihalides is replaced with an alkoxy or a halogenated alkoxy, and mixtures thereof;
the solvent system used in step (1) consists of an organic epoxy compound, an organo phosphorus compound and an optional inert diluent or, alternatively, of an alcohol compound and an optional inert diluent, with the alcohol compound being chosen from linear or branched aliphatic alcohol having 1 to 10 carbon atoms, cycloaliphatic alcohol having 3 to 12 carbon atoms, alkaryl alcohol having 6 to 20 carbon atoms, aralkyl alcohol having 6 to 20 carbon atoms, and mixtures thereof;
step (2) is carried out as follows: at a temperature of from −30° C. to 60° C., a titanium compound is combined with the solution from step (1), and then a co-precipitant is added thereto to form a mixture; alternatively, a co-precipitant is added to the solution from (1), and then at a temperature of from −30° C. to 60° C., the solution is combined with a titanium compound to form a mixture;
the internal electron donor compounds C, D, and E are independently chosen from the esters of diol represented by the general formula (I), alkyl esters of aliphatic or aromatic mono-basic carboxylic acids, alkyl esters of aliphatic or aromatic poly-basic carboxylic acids, aliphatic ethers, cycloaliphatic ethers, aliphatic katones, and mixtures thereof;
relative to one mole of the magnesium halide, the amount of the electron donor compound C used ranges from 0 to 3 moles, the amount of the electron donor compound D plus E used ranges from 0 to 5 moles, and the amount of the electron donor compound C+D+E used ranges from 0 to 5 moles;
the titanium compound used in step (2) and the titanium compound used in step (4) are the same or different, and they have a general formula: TiXₙ(OR)₄₋ₙ, in which R is independently a C₁-C₂₀ hydrocarbyl group, X is independently a halogen, and n=1 to 4; and
relative to one mole of the magnesium halide, the amount of the titanium compound used in step (2) ranges from 1.5 to 50 moles, and the amount of the total titanium compound used in step (2) and step (4) ranges from 2 to 150 moles.

18. The process of claim 13, wherein the solvent system used in step (1) consists of an organic epoxy compound, an organo phosphorus compound and an optional inert diluent,
wherein the organic epoxy compound comprises at least one of aliphatic epoxy compounds and diepoxy compounds, halogenated aliphatic epoxy compounds and diepoxy compounds, glycidyl ether, and inner ethers, having from 2 to 8 carbon atoms;
wherein the organo phosphorus compound comprises at least one of hydrocarbyl esters of orthophosphoric acid, halogenated hydrocarbyl esters of orthophosphoric acid, hydrocarbyl esters of phosphorous acid, and halogenated hydrocarbyl esters of phosphorous acid;
wherein the optional inert diluent is chosen from hexane, heptane, octane, decane, benzene, toluene, xylene, 1,2-dichloroethane, chlorobenzene, and other hydrocarbon and halogenated hydrocarbon solvents; and
wherein, relative to one mole of the magnesium halide, the amount of the organic epoxy compound used ranges from 0.2 to 10 moles; the amount of the organo phosphorus compound used ranges from 0.1 to 3 moles; and the amount of the inert diluent, if used, ranges from 0.1 to 10 liters per mole of the magnesium halide.

19. The process of claim 13, wherein the solvent system used in step (1) consists of an alcohol compound and an optional inert diluent, with the alcohol compound being chosen from linear or branched aliphatic alcohol having 1 to 10 carbon atoms, cycloaliphatic alcohol having 3 to 12 carbon atoms, alkaryl alcohol having 6 to 20 carbon atoms, aralkyl alcohol having 6 to 20 carbon atoms, and mixtures thereof, and the amount of the alcohol used ranging from 2.0 to 6.0 moles, relative to one mole of the magnesium halide.

20. The process of claim 13, wherein the internal electron donor compounds C, D, and E are independently chosen from phthalates, malonates, succinates, glutarates, pivalates, adipates, sebacates, maleates, naphthalene dicarboxylates, trimellitates, benzene-1,2,3-tricarboxylates, pyromellitates, and carbonates.

21. A catalyst component obtained by a process according to claim 13.

22. A catalyst for the polymerization of an alpha-olefin of a formula CH₂═CHR, in which R is hydrogen or an alkyl having 1 to 6 carbon atoms, comprising a reaction product of the following components:
1) the catalyst component according to claim 21;
2) an alkylaluminum compound as a cocatalyst; and
3) optionally, an external electron-donor compound.

23. The catalyst of claim 22, having at least one of the following features:
the alkyl aluminum compound is a compound represented by a general formula AlRₙX₃₋ₙ, in which R is independently hydrogen or a C₁-C₂₀ hydrocarbon radical; X is independently a halogen; and n has a value meeting 0<n≦3;
the alkyl aluminum compound is used in such an amount that a molar ratio of aluminum therein to titanium in the solid catalyst component (1) ranges from 5 to 5000;
the external electron donor compound is an organic silicon compound of a general formula RₙSi(OR′)₄₋ₙ, wherein 0<n≦3, R and R′ are independently chosen from optionally halogenated C₁-C₂₀ alkyl, C₂-C₂₀ alkenyl, C₃-C₂₀ cycloalkyl, C₆-C₂₀ aryl, and heteroaryl having 3 to 10 carbon atoms and 1 to 3 heteroatoms chosen from N, O and S, and R may also be halogen or hydrogen; and
the external electron donor compound is used in such an amount that a molar ratio of the alkyl aluminum compound to the external electron donor compound ranges from 0.1 to 500.

24. A process for polymerizing olefin, comprising
contacting an olefin of a formula CH₂═CHR, wherein R is H or an alkyl having 1 to 6 carbon atoms, optionally another kind of said olefin as a comonomer, and optionally a diene as a second comonomer, with the catalyst of claim 22 or 23 under polymerization conditions; and
recovering the resulting polymer.
